(19) United States
(12) Patent Application Publication
(10) Pub. No.: US 2005/0256622 A1
(43) Pub. Date: Nov. 17, 2005

(54) Driving stability management by a vehicle regulator system

(76) Inventors: Sylvia Futterer, LUDWIGSBURG (DE); Armin-Maria Verhagen, Schwieberdingen (DE); Karlheinz Frese, Illingen (DE); Manfred Gerdes, Vaihingen/Enz (DE)

Correspondence Address: KENYON & KENYON, ONE BROADWAY, NEW YORK, NY, 10004, US

(21) Appl. No.: 10/517,254

(22) PCT Filed: Mar. 18, 2003
(86) PCT No.: PCT/DE03/00870

§ 371 Date: Dec. 6, 2004

(30) Foreign Application Priority Data
Jun. 15, 2002 (DE) 10226683.2

(51) Int. Cl. G05D 1/00

(52) U.S. Cl. 701/48

(57) ABSTRACT

A method and a device for influencing the handling characteristics of a vehicle, by increasing the vehicle stability and hence increasing the driving comfort for the driver of the vehicle. This is done by activating at least two systems in the vehicle, which improve the handling characteristics and thus the vehicle stability. The activation of a system occurs in a specified sequence as a function of the activation and/or of the effect of the preceding systems on the handling characteristics achieved by the activation. The sequence provided for this purpose is the initial activation of a chassis system, followed by a steering system and finally by a brake system.

### FIELD OF THE INVENTION

The present invention relates to a method and a device for coordinating the subsystem of a vehicle dynamics network system. The increasing complexity and the rising number of electronic systems in vehicles, which actively affect handling characteristics or vehicle stability, requires a controller network in order to achieve an optimal interaction of the individual electronic systems.

### BACKGROUND INFORMATION

European Patent no. 0 507 072 discusses a network system, which relays the instruction to execute the driver command in a hierarchical structure of an overall system from top to bottom. This results in a clear structure having elements independent of one another.

German patent document no. 44 39 060 discusses a complex vehicle control system, which combines, for example, an antilock braking system (ABS) with a traction control system (TCS) and a yaw moment control (GMR) in a vehicle stability control (FSR). If an error occurs in this control system, then, if possible, only the affected component will be switched off.

German patent document no. 41 40 270 discusses a method, in which, during braking and/or acceleration maneuvers, the suspension systems are operated in such a way that on every wheel unit the current normal force between tire and road surface, or the wheel load, is influenced in the direction of its highest possible value.

German patent document no. 39 39 292 discusses a network control system comprising an active chassis control and an antilock braking system (ABS) and/or traction control system components (TCS), which, during the ABS or TCS control phases, always implement the damping force adjustments in such a way that wheel load fluctuations are minimal.

### SUMMARY OF THE INVENTION

The exemplary embodiment and/or exemplary method of the present invention is to a method or a device for influencing the handling characteristics of a vehicle. The influence is directed at increasing the vehicle stability while maintaining the driving comfort for the driver of the vehicle. This goal is achieved by activating at least two systems in the vehicle, which improve the handling characteristics and hence the vehicle stability. The activation of a system occurs in a specified sequence as a function of the activation and/or of the effect of the preceding systems on the handling characteristics achieved by the activation.

The emphasis here is primarily on the stabilization of the handling characteristics. The sequence is established on the basis of the effects of the interventions of the systems on the handling characteristics. A further important aspect in the choice of the sequence of the activated systems is the perceptible driving comfort of the driver. Thus priority is given to the intervention of a system, in which the driver of the vehicle least notices the effect of the intervention on the handling characteristics, i.e. the stabilizing effect. For example, an additional steering intervention for stabilizing the vehicle, which is superimposed on the steering interventions on the part of the driver and produced by the activated steering system, is noticed more distinctly than an intervention of the chassis system (e.g. an adjustment of the hardness of the spring or damper). Furthermore, a driver senses a braking action and hence a change in the longitudinal movement of the vehicle more strongly than is the case in an additional steering intervention. With the activation of a chassis system, followed by a steering system and finally a brake system, this results in a prioritization of the activation, which provides the driver with an increased vehicle stability with a high driving comfort at a minimal loss of speed or an optimized braking deceleration performance. The advantage vis-à-vis available strategies for peaceful coexistence is the increase of the overall utility without giving up the basic idea of autonomous subsystems.

In the exemplary embodiment and/or exemplary method of the present invention, the operating state of the activated system and/or the achievable effect on the handling characteristics are taken into account in the activation of the systems. This allows for a situation-dependent activation of the individual actuators of the system.

The exemplary embodiment and/or exemplary method of the present invention ascertains a deviation between specifiable nominal handling characteristics and the current actual handling characteristics. The handling characteristics are influenced subsequently by the activation of the systems as a function of the ascertained deviation.

In a further embodiment, the deviation between specified nominal handling characteristics, provided in particular as handling characteristics according to the driver command, and the current actual handling characteristics is ascertained by a stabilization variable, which represents the deviation. It is furthermore provided that a nominal yaw moment is assigned to the stabilization variable as a function of the stabilization variable. The activation of the systems can subsequently occur as a function of the ascertained nominal yaw moment.

An advantage of the exemplary embodiment and/or exemplary method of the present invention lies in the fact that the activation of the systems reduces the ascertained deviation between nominal and actual handling characteristics to a minimum. An increase in vehicle stability can thereby be achieved. The functional activation of the systems in the specified sequence is arranged or configured to reduce the deviation to a minimum by the activation of a preceding system. The reduction of the deviation achieved in preceding systems is then taken into account in the activation of the subsequent systems.

Checking the necessity of activating subsequent systems, which is performed following the implemented activation of a preceding system, also has an advantageous effect. Thus, if the deviation between the nominal and the actual handling characteristics has been sufficiently reduced by preceding systems, an activation of subsequent systems in the sequence may be omitted.

For influencing handling characteristics, particularly vehicle stability, the exemplary embodiment and/or exemplary method of the present invention is arranged or configured to influence a force between the vehicle body and at least one wheel unit by activating a chassis system. For example, an advantageous adjustment of the spring and/or damping property of the chassis may be performed on this basis. The handling characteristics may be additionally influenced by activating the position of at least one steerable wheel of a steering system. As in the case of a chassis system and a steering system, an advantageous influence on the handling characteristics may also be exerted via the activation of a brake system. Thus the activation of the braking force of at least one wheel of the motor vehicle can have a favorable effect on the handling characteristics in that critical driving situations are detected and mitigated independently of the situation of the driver.

### BRIEF DESCRIPTION OF THE DRAWINGS

FIG. 1 shows the intake of the operating parameters of the systems within the vehicle controller network as well as the activation of the vehicle dynamics systems.

FIG. 2 shows in a flow chart the processing of the deviation between nominal and actual handling characteristics and the influence of the vehicle dynamics systems on the handling characteristics.

FIG. 3 shows the control sequence in the vehicle network system.

FIG. 4 shows the algorithm for calculating the normal force intervention of a chassis system in the vehicle network.

FIG. 5 shows the determination of the lateral force intervention of a steering system.

FIG. 6 shows the determination of the longitudinal force intervention of a brake system.

### DETAILED DESCRIPTION

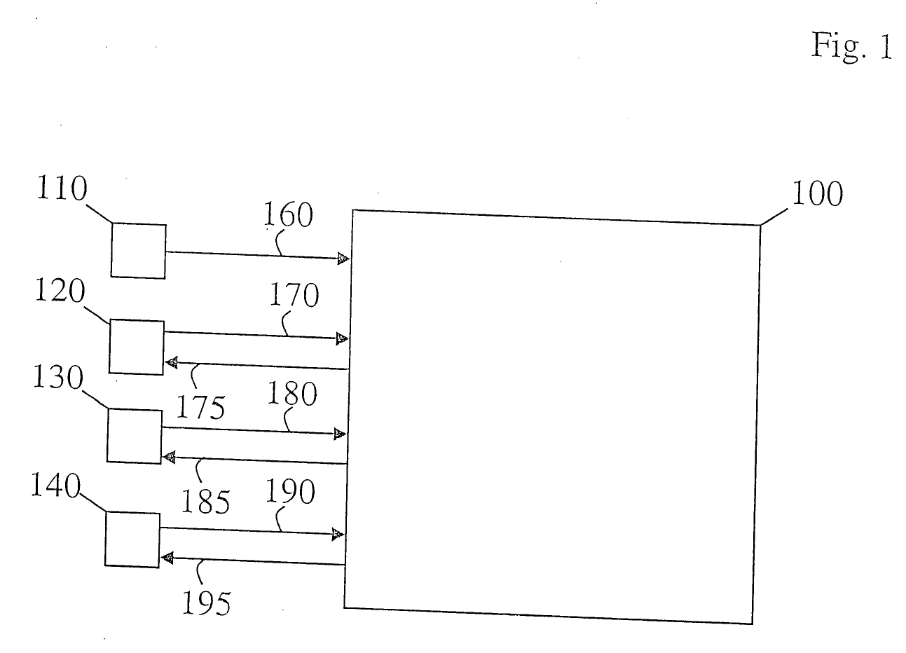

FIG. 1 shows an exemplary embodiment for influencing the handling characteristics of a motor vehicle, with special emphasis being placed on increasing the vehicle stability. In addition to the current actual yaw rate Ψ_{act} (160) from a yaw-rate sensor 110, the performance quantities 170, 180, 190 of the existing systems, chassis control 120, steering 130 and vehicle dynamics control 140, are read in the control block 100. From the ascertained or determined performance quantities (170, 180, 190), the nominal yaw rate In case of a deviation between the actual value 160 and the nominal value 210 of the yaw rate On the basis of these interventions, the roll inclination may be suppressed by stabilizing interventions 175 using a chassis system 120, as can be implemented, for example, by an electronic active roll stabilizer (EAR) or an active body control (ABC). In addition, with the use of such a chassis component, the roll momentum distribution (e.g. the oversteering and understeering behavior) may be influenced.

With the help of a steering system 130, as featured in electronic active steering (EAS) or steer by wire (SbW) systems, in addition to the steering movements of the driver, steering interventions 185, which result in an increase in the vehicle stability may be superimposed on the steering. In addition, with the activation of a vehicle dynamics control 140, as is implemented by an electronic stability program (ESP), vehicle-stabilizing brake interventions 195 may be undertaken.

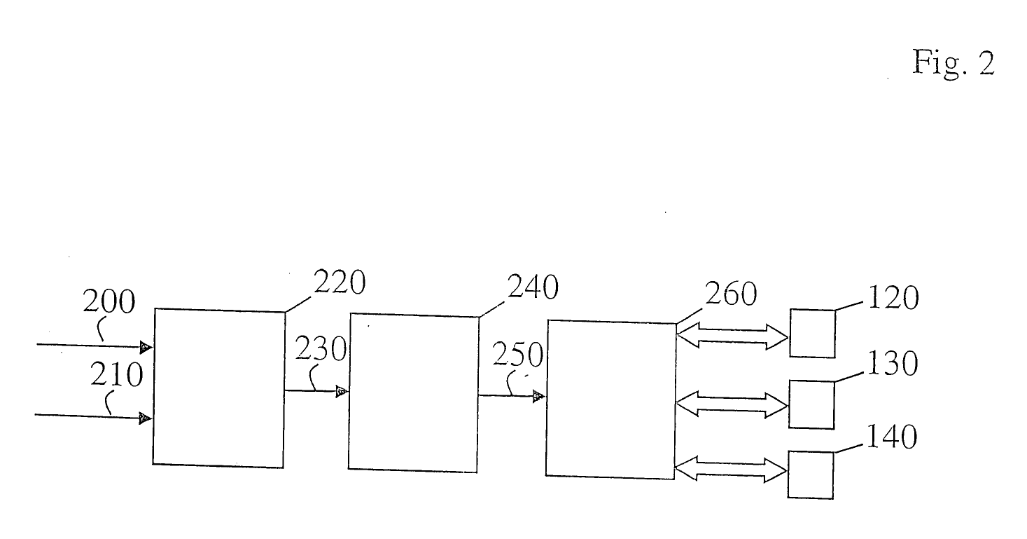

In a block diagram, FIG. 2 depicts the mode of operation in the ascertainment of the necessary control interventions for increasing the vehicle stability. By comparing a suitable actual value 200 with nominal value 210, a system deviation 230 is ascertained in block 220. System deviation 230, for example, can be formed by a difference between the actual yaw rate Furthermore, however, a formation of the system deviation by comparing the actual sideslip angles with the nominal sideslip angles is conceivable as well. Based on system deviation 230 thus obtained, a nominal yaw moment M_{Z} (250) with regard to the vehicle's gravitational center is calculated in block 240 for the required stabilization of the handling characteristics. Nominal yaw moment M_{z} (250) thus ascertained from system deviation 230 is relayed as an actuating command to vehicle controller network 260. From this vehicle controller network, chassis system 120, steering system 130 and brake system 140 are activated in the specified sequence and as a function of their possible influence on the handling characteristics.

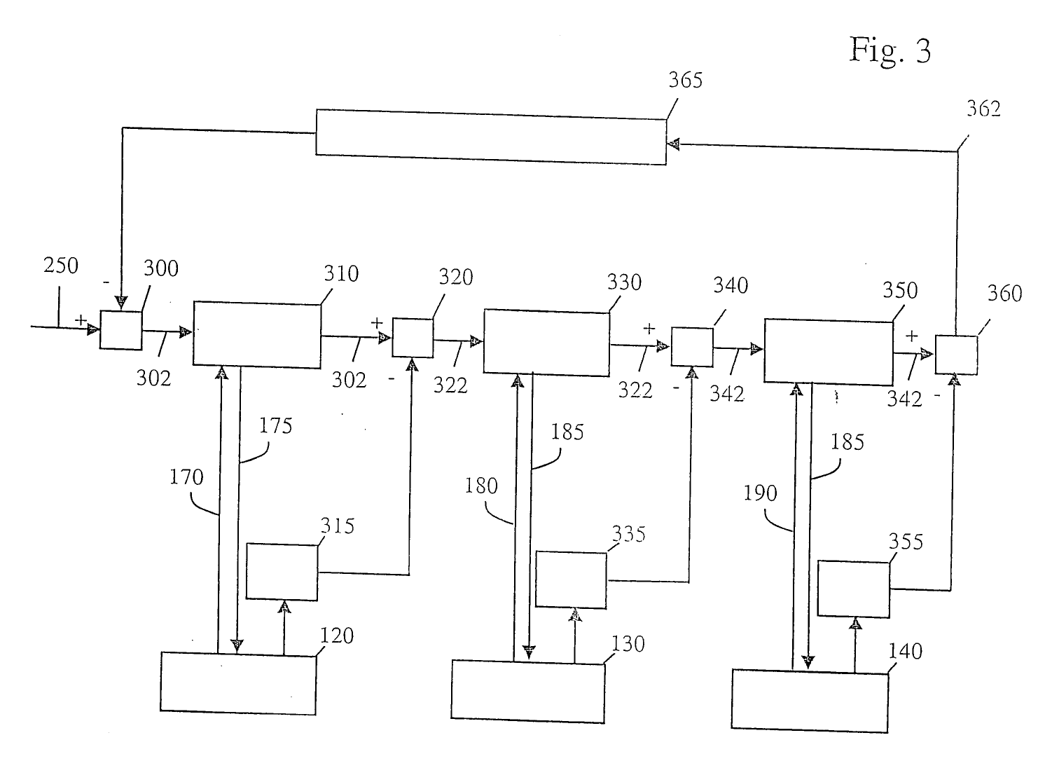

The flow chart in FIG. 3 shows the implementation of the activation of the control systems in the specified sequence and as a function of nominal yaw moment M_{z} (250). Based on the originally ascertained nominal yaw moment M_{z} (250), a modification is performed on nominal yaw moment 250 in block 300, which is necessary due to a residue moment 360 of a preceding control intervention. In block 310, current nominal yaw moment 302 thus ascertained is used as a function of current performance quantities 170 of the chassis to determine the intervention of chassis system 120 in the moment modification of the vehicle's gravitational center. In the process, the calculated chassis interventions are converted into actuating commands 175 for the chassis. The moment modification with regard to the vehicle's gravitational center produced by the intervention in chassis system 120 is subsequently determined in block 315 and is used in block 320 for modifying nominal yaw moment 302.

The residue yaw moment 322 thus produced is then used in block 330, corresponding to the procedure in the activation of the chassis control, as a function of the current performance quantities of steering 180 for determining the intervention of steering system 130 in the moment modification of the vehicle's center of gravity. In the process, the calculated steering interventions are converted into actuating commands 185 for steering system 130. The moment modification with regard to the vehicle's gravitational center produced by the intervention is then determined in block 335 and is used in block 340 for modifying residue yaw moment 322. Residue yaw moment 342 thus produced is subsequently used in block 350, corresponding to the procedure in the activation of the preceding vehicle controls, as a function of the current performance quantities (190) of the brake system for determining the intervention of brake system 140 in the moment modification of the vehicle's center of gravity. In the process, the calculated brake interventions are converted into actuating commands 185 for the brake system.

The moment modification with regard to the vehicle's gravitational center produced by the intervention is then determined in block 355 and is used in block 360 for modifying residue yaw moment 342. If it is established in the process that following the brake intervention there is still a remaining residue moment 362, then this can be used via a model correction 365 to perform an additive correction of the moment balance in block 300. Using nominal yaw moment 302 thus updated, the activation of the control systems can be run through anew.

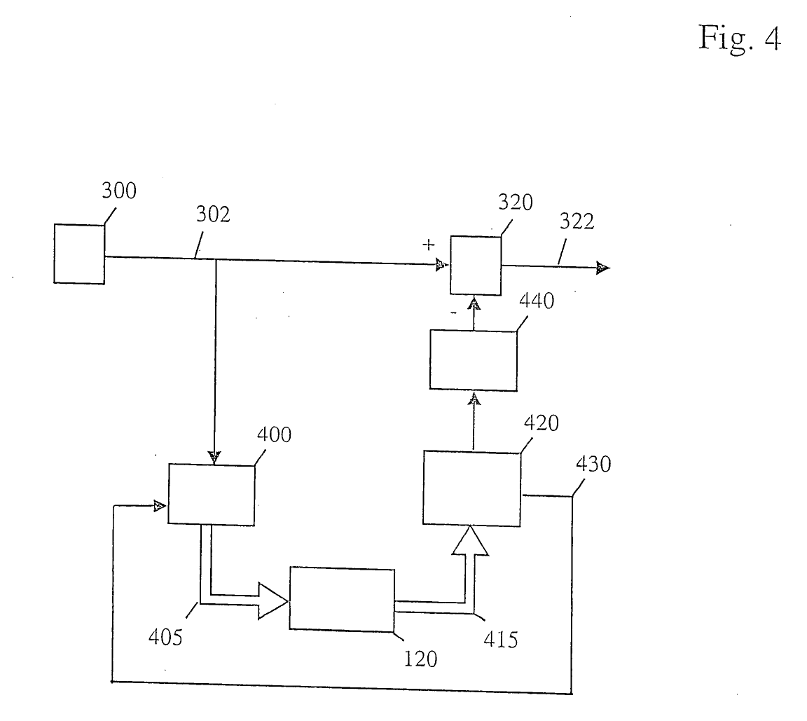

The calculation and the verification of the chassis interventions is represented in the flow chart of FIG. 4. These interventions can be used to produce modifications of the normal forces that act from the wheels perpendicularly to the ground below. In the present exemplary embodiment, the modification of the normal forces at the wheels of the vehicle is used to bring about a modification of the nominal yaw moment M_{z} (302) with regard to the gravitational center. For calculating the required normal force interventions, a controller algorithm is used in block 400. For activating the individual actuators of chassis system 120, the actuating reserves 430 of the normal forces at the actuators as well as the current operating state of the actuators of the chassis are taken into account. In this manner, for example, the situation can be prevented that an actuator is activated which has no road adhesion and which hence cannot effect a modification of the normal force. Furthermore, the failure of an actuator can be taken into account in the activation. Via an inverse vehicle model in block 400, the required nominal actuating variables 405 are ascertained from the intervention selection made and are transferred to the control unit of chassis system 120.

As feedback of the chassis system, the actual actuating variables 415 of the actuators are queried in block 420. Together with the general operating state variables of the components and a chassis model, these actual actuating variables 415 are converted into a normal force distribution. This distribution is used to determine the actuating reserves of normal forces 430. Finally, in block 440, the moment modification with regard to the vehicle's gravitational center through the chassis interventions is estimated with the help of the vehicle geometry. The reduction of the yaw moment thereby ascertained is subtracted from nominal yaw moment 302 and yields residue yaw moment 322.

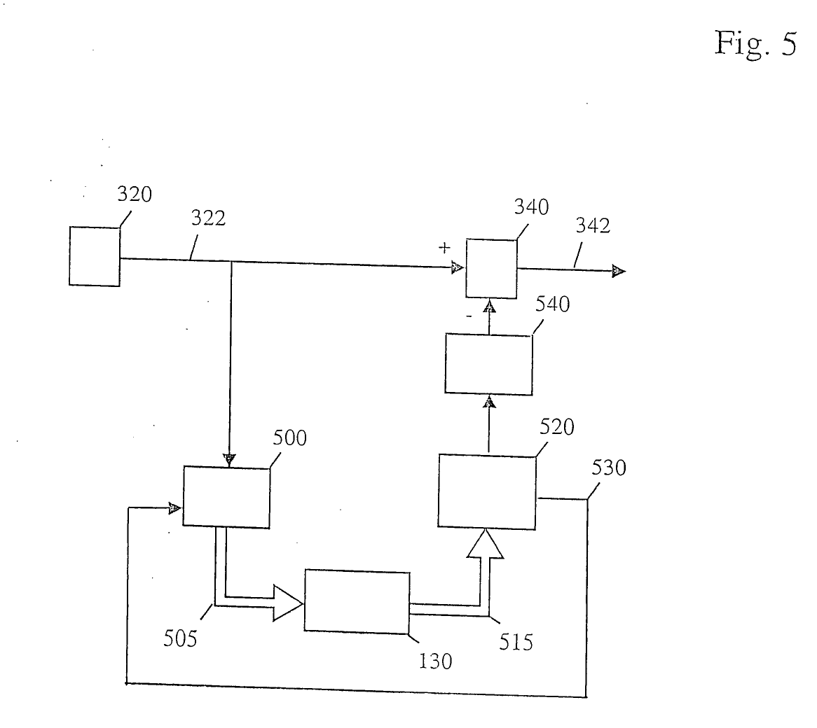

Following the procedure in ascertaining the interventions of the chassis control for modifying the yaw moment in FIG. 4, the flow chart of FIG. 5 shows the calculation and the verification of the steering interventions of steering system 130. In the present exemplary embodiment, the modification of residue yaw moment 322 with regard to the gravitational center is brought about by a modification of the lateral forces on the steerable wheels. For calculating the required lateral force interventions, a controller algorithm is used in block 500. For activating steering system 130, actuating reserves 530 of the lateral forces on the wheels are taken into account as well as the current operating state of the wheels.

In this manner, for example, the situation can be prevented that a wheel is activated which has no road adhesion and which hence cannot effect a modification of the lateral force. Via an inverse vehicle model, the required nominal steering angles 505 of the wheels are calculated and transferred to steering system 130. As feedback of the steering system, the actual steering angles 515 of the wheels are queried in block 520. Together with a tire model, actuating reserves 530 for modifying the lateral forces are ascertained from these actual steering angles 515. Finally, in block 540, the moment modification with regard to the vehicle's gravitational center through the steering interventions is estimated with the help of the vehicle geometry. The reduction of the yaw moment thus ascertained is subtracted from residual yaw moment 322, thereby yielding the new, updated residual yaw moment 342.

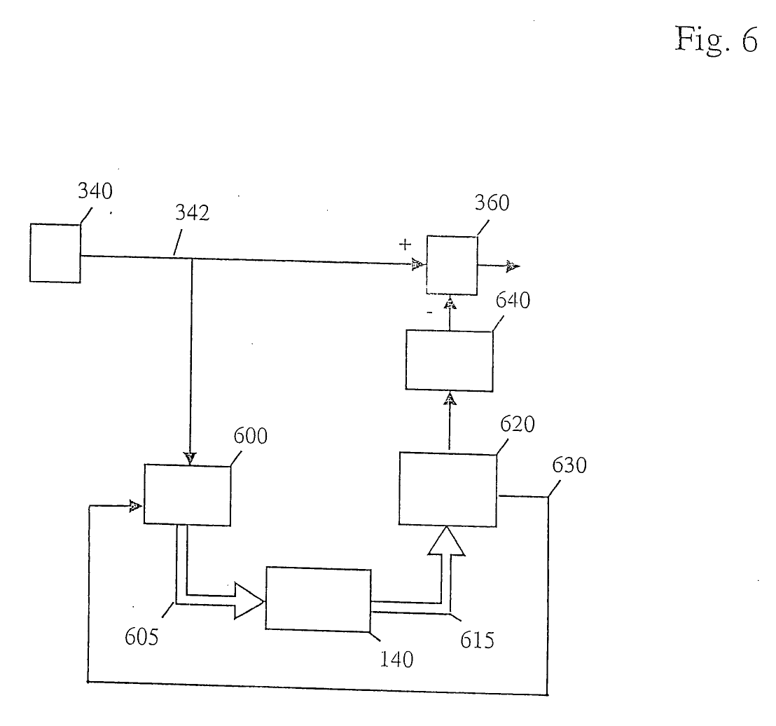

As already shown in the chassis interventions in FIG. 4 and the steering interventions in FIG. 5, FIG. 6 shows a flow chart describing the calculation, control and verification of the brake interventions. In the present exemplary embodiment, the modification of residue yaw moment 342 with regard to the gravitational center is brought about by a modification of the longitudinal force on the vehicle. For calculating the required longitudinal force interventions, a controller algorithm is used in block 600. For activating the individual actuators of brake system 140, actuating reserves 630 of the longitudinal forces on the wheel brakes of the vehicle as well as the current operating state of the brake system are taken into account. In this manner, for example, the situation can be prevented that a brake activation by the vehicle controller network counteracts another brake activation.

The ascertained brake interventions are transferred to the control unit of brake system 140 via an inverse vehicle model as required nominal variables 605 on the wheels. As feedback of brake system 140, actual slip variables 615 are queried in block 620. Together with the general operating state variables of the brake system and a chassis model, these actual slip variables 615 are converted into a longitudinal force distribution. This distribution can be used to determine actuating reserves 630 of the longitudinal forces. Finally, in block 640, the moment modification with regard to the vehicle's gravitational center through the brake interventions is estimated with the help of the vehicle geometry. The thus ascertained reduction of the yaw moment is subtracted from residue yaw moment 342 and yields a possibly remaining residual moment 362.

1-10. (canceled)

11. A method for coordinately activating at least two systems of a motor vehicle, the method comprising:
influencing handling characteristics of the motor vehicle and following an activation sequence of at least one of a chassis control system, a steering system and a braking system; and
activating a subsequent system in the sequence so as to occur, in at least some of the activations of the systems, as a function of at least one of the activation and an effect on the handling characteristics achieved by the activation of a preceding system in the sequence.

12. The method of claim 11, wherein in the activation of one of the systems, at least one of the operating state and the system's effect on the handling characteristics achievable by the activation are taken into account.

13. The method of claim 11, further comprising:
determining a deviation between specifiable nominal handling characteristics and current actual handling characteristics, wherein the activation occurs as a function of the determined deviation.

14. The method of claim 11, further comprising:
determining a stabilizing variable representing the deviation between specifiable nominal handling characteristics, nominal handling characteristics by a driver command being provided, and current actual handling characteristics; and
determining a nominal yaw moment as a function of a stabilizing variable, the activation of the systems occurring as a function of a nominal yaw moment.

15. The method of claim 13, wherein the activation is performed so as to reduce the determined deviation to a minimum, the activation occurring so that the minimum is achieved by the activation of a preceding system in the sequence, and wherein in the activation of a system the minimization of the deviation achieved from the activation of preceding systems is taken into account.

16. The method of claim 11, wherein in the activation of a subsequent system, following an implemented activation of a system, a necessity of an additional activation of a subsequent system is verified.

17. The method of claim 11, wherein at least one of the following is satisfied:
by activating the chassis control system, a force between the vehicle body and at least one wheel unit is influenced, through an adjustment of at least one of a spring and a damping property,
by activating the steering system, a position of at least one steerable wheel of the motor vehicle is influenced, and
by activating the braking system, a braking force on at least one of the wheels of the motor vehicle is influenced.

18. A device for coordinately activating at least two systems of a motor vehicle, comprising:
an influencing arrangement to influence handling characteristics of the motor vehicle and follow an activation sequence of at least one of a chassis control system, a steering system, and a braking system, wherein the activation of a subsequent system in the sequence occurs, in at least some of the activations of the systems, as a function of at least one of the activation and an effect on the handling characteristics achieved by the activation of a preceding system in the sequence.

19. The device of claim 18, wherein in the activation of a system at least one of an operating state and the effect of the system on the handling characteristics achievable by this activation are taken into account.

20. The device of claim 18, further comprising:
a first arrangement to determine a deviation between specifiable nominal handling characteristics and current actual handling characteristics;
a second arrangement to perform the activation as a function of the determined deviation.
